(19) United States
(12) Patent Application Publication
(10) Pub. No.: US 2017/0254352 A1
(43) Pub. Date: Sep. 7, 2017

(54) FASTENER

(71) Applicant: ESSENCE METHOD REFINE CO., LTD., TAINAN CITY (TW)

(72) Inventor: LING-FANG CHEN, TAINAN CITY (TW)

(21) Appl. No.: 15/598,639

(22) Filed: May 18, 2017

Related U.S. Application Data
(63) Continuation-in-part of application No. 14/540,246, filed on Nov. 13, 2014.

(51) Int. Cl. F16B 25/00

(52) U.S. Cl. CPC F16B 25/0047; F16B 25/0021; F16B 25/0015; F16B 25/0068

(57) ABSTRACT

A fastener includes a shank defining a shank root, a head, a drilling portion and main threads. The main threads divide the shank root into recessed root sections. Each main thread with two cutting faces which converge at an edge is inclined to a shank axis by 60 to 82 degrees. At least one main lobe projects from the recessed root section and flares outward to at least a midpoint of at least one cutting face between the recessed root section and the edge of the main thread. The inclination allows the main threads to have a large rotating angle for increasing cutting and drilling efficiency. The extension of the main lobe supports the main thread to bear the drilling stress to prevent the shank and main threads from snapping and allow debris accommodation to provide a firm fastening effect.

### CROSS-REFERENCE TO RELATED APPLICATION

This invention is a continuation-in-part of the U.S. patent application Ser. No. 14/540,246, filed on 13 Nov. 2014, currently pending, of which the subject matter is incorporated herein by reference in its entirety.

### BACKGROUND OF THE INVENTION

1. Field of the Invention

This invention relates to a fastener and relates particularly to a fastener with a good fastening effect and better mechanical characteristics, such as good performance for torsion resistance and tensile strength.

2. Description of the Related Art

Referring to FIG. 1, a conventional screw 1 includes a shank 11, a head 12 disposed on one end of the shank 1 and a plurality of threads 13 spirally disposed on the shank 11. To speed up the drilling action, the thickness of the thread 13 is reduced to sharpen the thread 13. In use, a rotary force is imparted to the head 12 to drill the threads 13 into an object 2 and screw the screw 1 into the object 2.

The screw 1 has some problems in the use. For example, the threads 13 are rapidly rolled and formed on the shank 11 by using thread rolling plates (not shown). Generally, thread rolling plates need some teeth to engage an outer wall of the shank 11 so that the threads 13 can be formed on the shank 11. The outer wall of the shank 11, however, becomes uneven when the threads 13 are rolled on the shank 11. The screw 1 has poor flexibility and poor torque values because of the uneven portion formed on the shank 11 and this even portion snaps easily under a large drilling stress, with the result that the fastening effect of the screw 1 is not good. Even though the screw 1 can be fastened to the object 2 successfully, the screw 1 may be over twisted and becomes deformed potentially. This situation may cause the screw 1 to snap inside the object 2 automatically and invisibly under the stress.

The threads 13 with a small thickness facilitate a sharp cutting effect to speedup the drilling action. However, the high temperature of the thermal treatment for processing threads renders the thin threads 13 a higher superficial temperature and causes the threads 13 to split and break easily under a slight pressure of the drilling action. Thus, the drilling action becomes slow, not fast. In contrast, the threads 13 with a large thickness may prevent the screw 1 from breaking easily, but the threads 13 becomes more and more passivated after a long term of use. This also slows the drilling action down. Therefore, the conventional screw 1 still needs to be improved.

### SUMMARY OF THE INVENTION

The object of this invention is to provide a fastener which prevents the shank from snapping and prevents the resonant vibratory effect after the fastener is screwed into the object, thereby attaining a firm fastening effect.

Accordingly, the fastener in accordance with this invention includes a shank defining a shank root, a head and a drilling portion disposed at two ends of the shank and a plurality of main threads spirally disposed on the shank and dividing the shank root into recessed root sections. Each of the main threads includes two inclined cutting faces extending respectively outward from any two adjacent recessed root sections to converge at an edge. Each main thread is inclined with respect to a shank axis by 60 to 82 degrees. At least one main lobe projects from the recessed root section to at least one cutting face of each main thread, with the main lobe flaring outward to at least a midpoint of the cutting face between the recessed root section and the edge. Accordingly, the inclining angle allows the main threads to have a large rotating angle at the time of drilling, thereby speeding up the drilling action and attaining a better drilling efficiency. By the main lobe in cooperation with the main threads and the shank, the fastener attains a preferable performance for torque and flexibility, enhances the torsion resistance and the tensile strength against the drilling stress to prevent the fastener from snapping, and decreases the resonant vibratory effect caused by external vibrations to attain a firm fastening effect.

Preferably, the main lobe can be formed in a curved shape.

Preferably, the recessed root section can be formed in a curved shape.

Preferably, in one preferred embodiment, two main lobes can project from any two adjacent recessed root sections to the two cutting faces of each main thread respectively.

Preferably, in one preferred embodiment, at least one auxiliary thread can be disposed between any two adjacent main threads. A diameter of the auxiliary thread is smaller than a diameter of each main thread.

Preferably, in one preferred embodiment, the auxiliary thread includes two auxiliary cutting faces connected with each other. In other words, the two auxiliary cutting faces extend outward from the recessed root section respectively to converge at an auxiliary edge. At least one support lobe can project from the recessed root section of the shank to at least one auxiliary cutting face of the auxiliary thread. It is also allowed that the support lobe flare outward to at least a midpoint of the auxiliary cutting face between the recessed root section and the auxiliary edge.

Preferably, in one preferred embodiment, the shank has a plurality of slits recessedly defined thereon, with the slits extending between two adjacent main threads. Each of the slits is intersected with the shank root of the shank to form a cutting edge.

Preferably, the drilling portion has a helical section coming to a sharp leading point.

Preferably, in one preferred embodiment, each of the main threads includes a plurality of notches formed thereon.

The advantages of this invention are more apparent upon reading following descriptions in conjunction with accompanying drawings.

### BRIEF DESCRIPTION OF THE DRAWINGS

FIG. 1 is a schematic view showing a conventional screw;

FIG. 2 is a schematic view showing a first preferred embodiment of this invention;

FIG. 3 is a cross-sectional view showing the first preferred embodiment of this invention;

FIG. 4 is a schematic view showing a second preferred embodiment of this invention;

FIG. 5 is a cross-sectional view showing the second preferred embodiment of this invention;

FIG. 6 is a schematic view showing a third preferred embodiment of this invention;

FIG. 7 is a cross-sectional view showing the third preferred embodiment of this invention;

FIG. 8A and FIG. 8B are schematic views showing the variations of the drilling portion of this invention;

FIG. 9 is a schematic view showing the drilling portion of this invention in a sharply-pointed structure;

FIG. 10 is a schematic view showing a fourth preferred embodiment of this invention;

FIG. 11 is a cross-sectional view showing the fourth preferred, embodiment of this invention;

FIG. 12 is a schematic view showing a fifth preferred embodiment of this invention;

FIG. 13 is a cross-sectional view showing the fifth preferred embodiment of this invention;

FIG. 14 is a schematic view showing a sixth preferred embodiment of this invention;

FIG. 15 is a cross-sectional view showing the sixth preferred embodiment of this invention;

FIG. 16 is a schematic view showing a seventh preferred embodiment of this invention

FIG. 17 is a cross-sectional view showing the seventh preferred embodiment of this invention;

FIG. 18 is a schematic view showing an eighth preferred embodiment of this invention in one variation;

FIG. 19 is a cross-sectional view showing the A-A part of FIG. 18;

FIG. 20 is a schematic view showing the eighth preferred embodiment of this invention in another variation;

FIG. 21 is a schematic view showing a ninth preferred embodiment of this invention;

FIG. 22 is a schematic view showing a tenth preferred embodiment of this invention;

FIG. 23 is a schematic view showing an eleventh preferred embodiment of this invention; and

FIG. 24 is a schematic view showing a twelfth preferred embodiment of this invention.

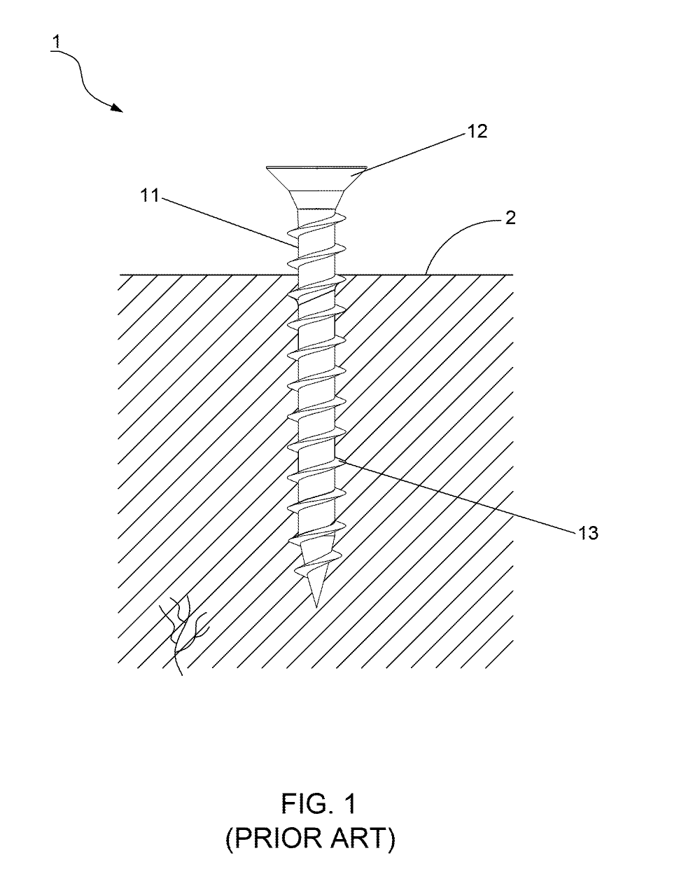

### DETAILED DESCRIPTION OF THE PREFERRED EMBODIMENTS

A fastener 3 of this invention is applied to various materials, such as plastic materials, light metal alloy materials and materials with fibers. Herein, only the material with fibers is adopted as an example.

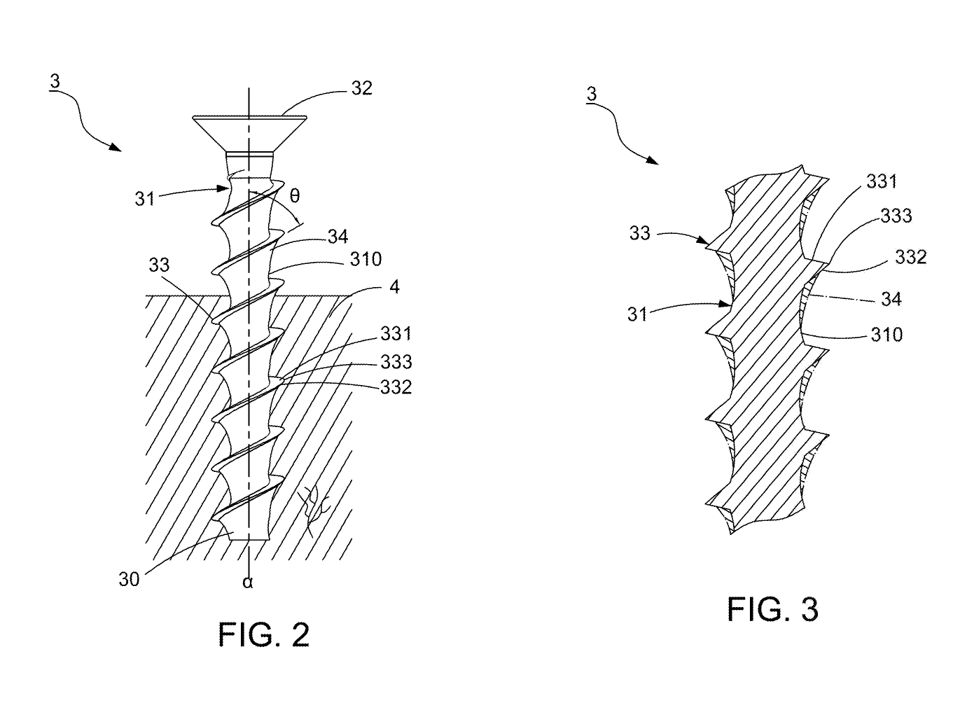

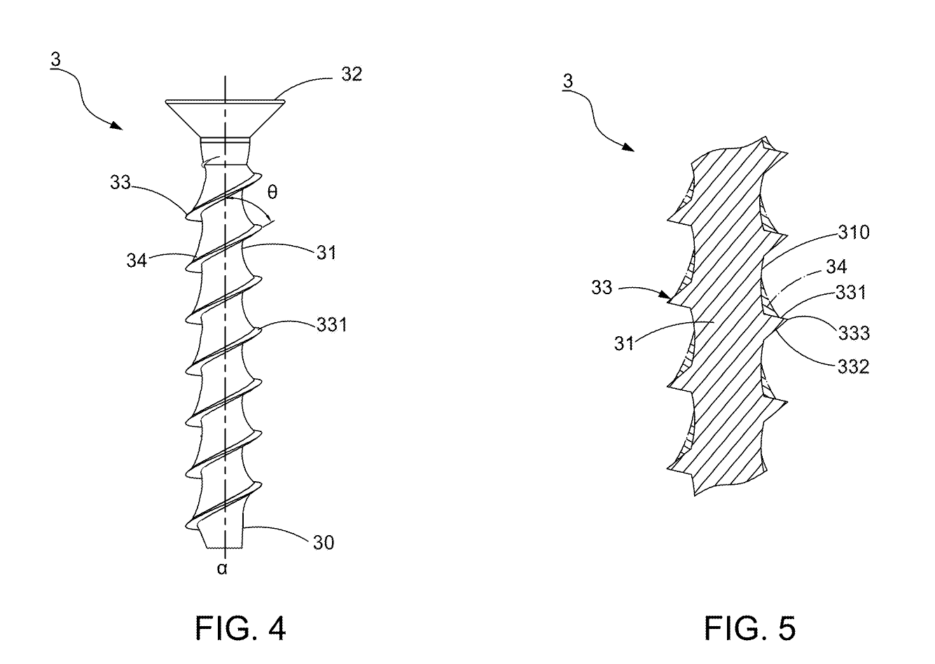

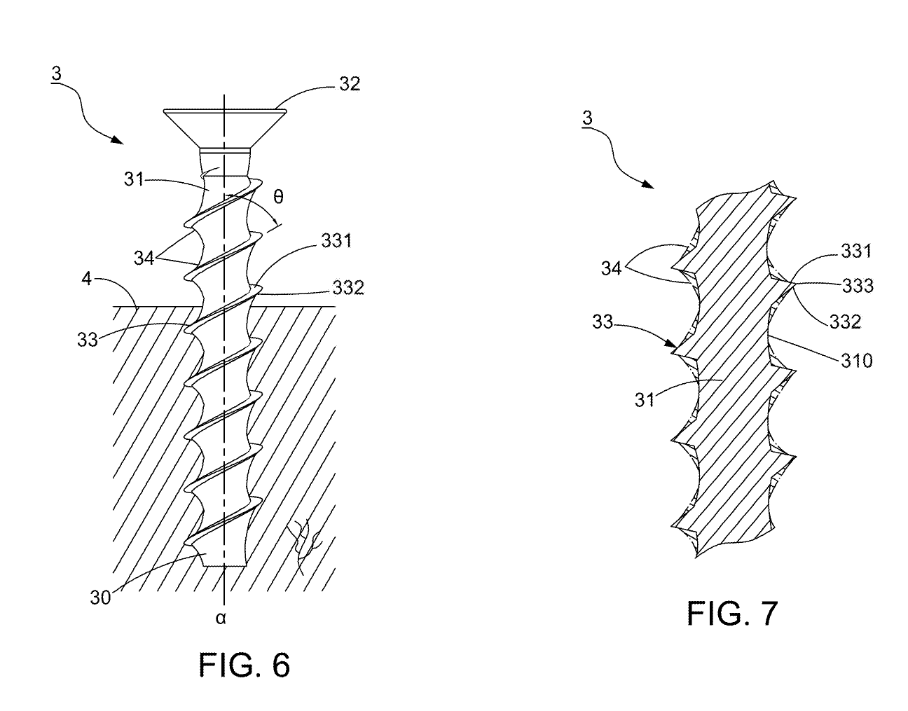

Referring to FIGS. 2-3, a first preferred embodiment of this invention includes a shank 31 defining a shank root, a head 32 disposed at one end of the shank 31, a drilling portion 30 disposed on the other end of the shank 31, and a plurality of main threads 33 spirally disposed on the shank 31. The main threads 33 divides the shank root into a plurality of recessed root sections 310, as shown. The root section 310 can be, but limited to, formed in a curved shape or other shapes recessed into the shank root. In all preferred embodiments of this invention, only the curved root section 310 is shown as an example. Each of the main threads 33 further includes two inclined cutting faces 331, 332 connected with each other. The cutting faces 331, 332 extend respectively outward from any two adjacent recessed root sections 310 to converge at an edge 333. Each of the main threads 33 is inclined with respect to a shank axis α by an angle β, preferably between 60 degrees and 82 degrees. The configuration of the main thread 33 can be adjusted according to the hardness of an object 4. In other words, the thickness and the height of the main thread 33 can be adjustably added or lessened to help the cutting and drilling performance. Furthermore, at least one main lobe 34 is designed to project from the shank 31 to at least one cutting face of each main thread 33. Specifically, the main lobe 34 flares outward to at least a midpoint of at least one cutting face between the recessed root section 310 and the edge 333 of the main thread 33. The main lobe 34 can be preferably formed in a curved shape. For example, FIGS. 2-3 show the main lobe 34 spreads upwards from the curved root section 310 to at least a midpoint of the lower cutting face 332 to support the main thread 33. FIGS. 4-5 show the main lobe 34 spreads downwards from the root section 310 to at least a midpoint of the upper cutting face 331 of the main thread 33, and the lower cutting face 332 with no main lobe 34 can be a smooth face or an angular face to impart a downward pressure to the fastener 3 and prevent the fastener 3 from loosening from the object 4. The fastener 3 attains a high power to resist vibrations after the drilling operation, thereby increasing the tensile strength. FIGS. 6-7 show the main lobes 34 spread from the adjacent root sections 310 respectively to at least a midpoint of both of the cutting faces 331,332.

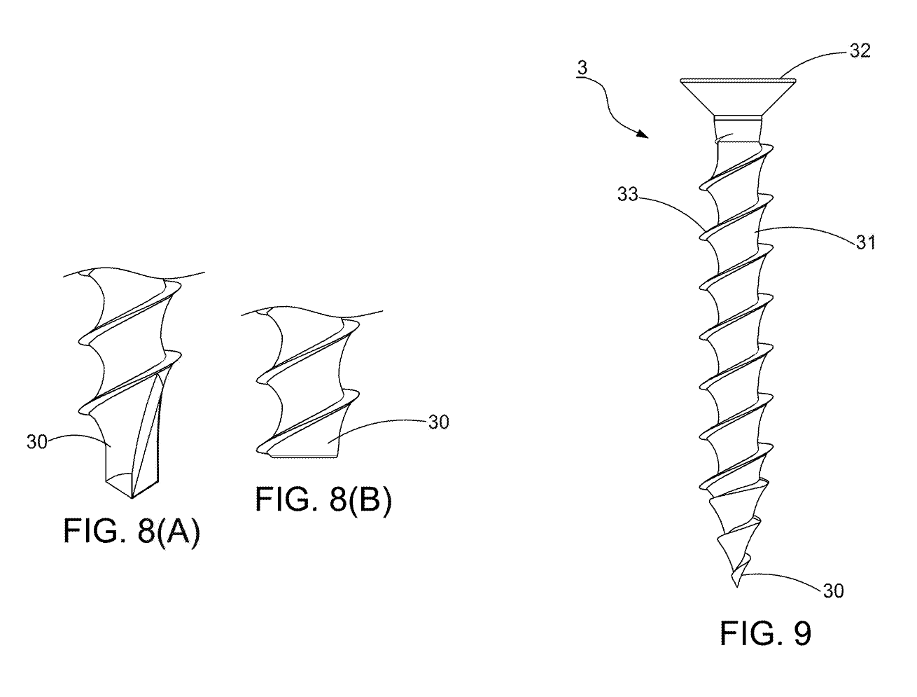

Furthermore, the drilling portion 30 can include, but not limited to, a narrow end surface as shown in FIG. 2, a drill tip with grooves as shown i FIG. 8A, a flat end surface as shown in FIG. 8B and/or a helical section coming to a sharp leading point as shown in FIG. 9. The drilling portion 30 with the sharp leading point is formed by rolling so that the rolled part becomes denser and stronger. Accordingly, the drilling portion 30 can drill the sharp leading point into the object 4 by hammering or screwing rotably.

The operation of the fastener 3 is explained with the aid of FIGS. 6-7. The head 32 is rotated by a rotation force to drive the main threads 33 into an object 4. During the drilling operation, the inclined angle θ of each main thread 33 ranging from 60 to 82 degrees allows the main threads 33 to rotate and drill into the object 4 with a larger rotating angle, thereby benefiting the fastening action and allowing debris accommodation. Further, the extension of the main lobes 34 to the cutting faces 331, 332 between the recessed root section 310 and the edge 333 allows the main thread 33 to keep the sharpness of the edge 333 and its thickness without changes and functions as an extended part of the shank 31 which supports the main threads 33, thereby facilitating a rapid drilling action and helping bear the successive drilling stress impinging on the drilling operation. The recessed root section 310, e.g. in a curved shape, facilitates the removal and accommodation of cut debris and cooperates with the main lobe 34 to support the main thread 33. The main lobes 34 with a curved slope, providing the supporting power, also prevent the shank 31 from twisting and snapping and prevent the main threads 33 from breaking or cracking at the time of drilling. Therefore, the drilling efficiently is largely increased. The fiber debris surrounding the main threads 33 is moved along the periphery of each main lobe 34 so that the debris can be expelled from the object 4, and the residual debris surrounding the shank 31 stays at the center of the main lobe 34. In this situation, the resonant vibratory effect caused by external forces after the fastener 3 is screwed into the object 4 is prevented, with the result that the fastener 3 is not easily pulled out by any external vibrations. Thus, the drilling operation can work smoothly and the fastener 3 can be firmly screwed into the object 4.

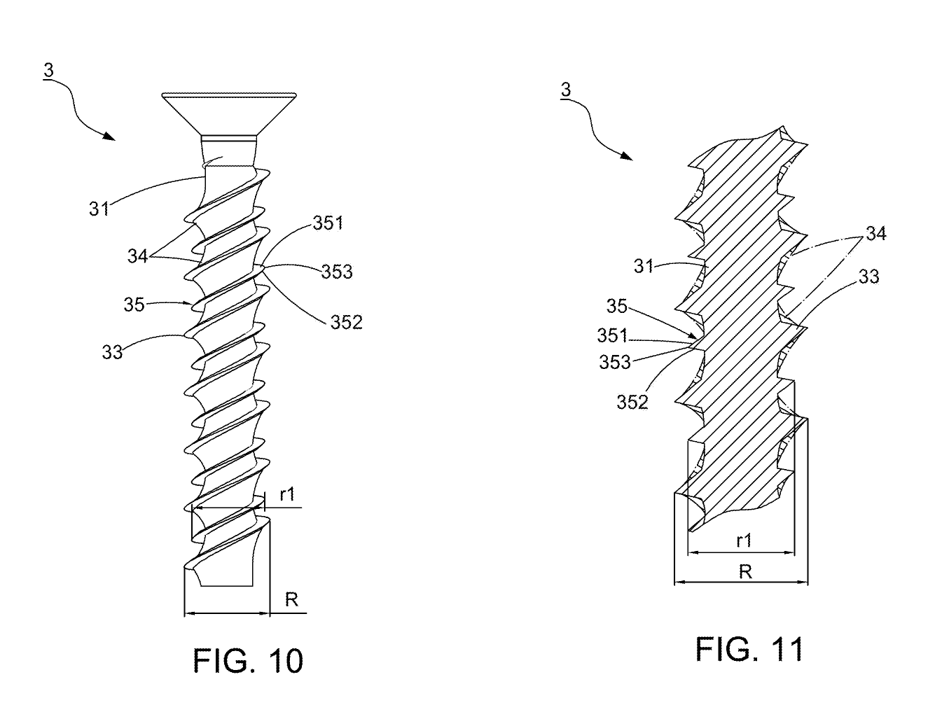

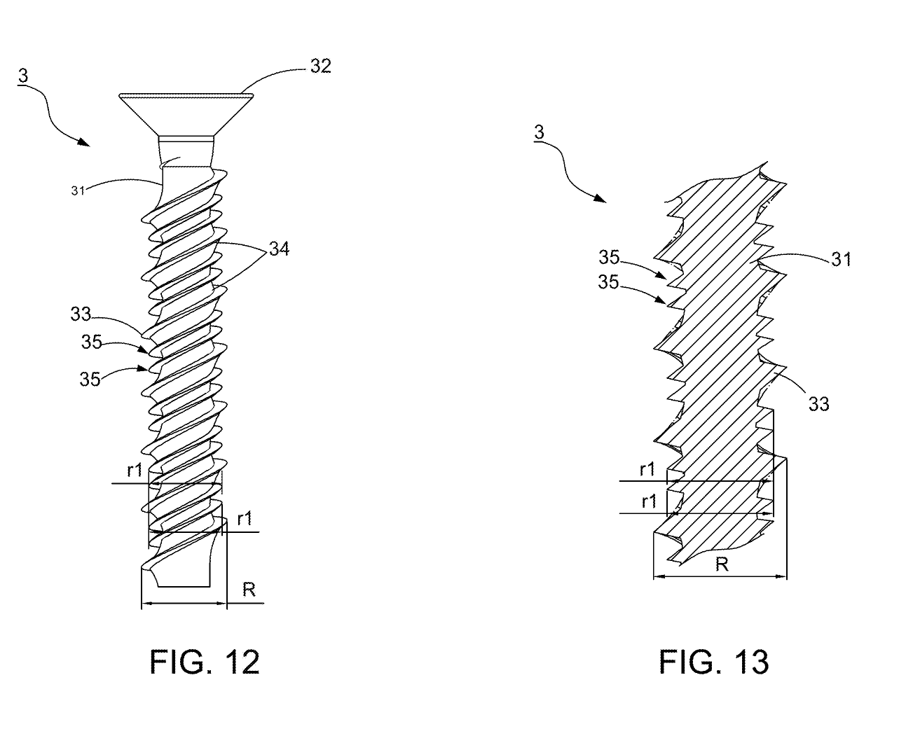

Referring to FIGS. 10-11, a fourth preferred embodiment of this invention has main elements which are the same as those of the previous preferred embodiments and has the same effects as those of the previous embodiments. This embodiment is characterized in that at least one auxiliary thread 35 is disposed between any two adjacent main threads 33. A diameter r1 of the auxiliary thread 35 is smaller than a diameter R of each main thread 33. The auxiliary thread 35 includes two auxiliary cutting faces 351, 352 connected with each other. The two auxiliary cutting faces 351, 352 extend outward from the recessed root section respectively to converge at an auxiliary edge 353. This invention can also include two or more auxiliary threads. For example, FIGS. 12-13 show that two auxiliary threads 35 are disposed between two adjacent main threads 33. The respective diameters r1 of the two auxiliary threads 35 can be identical or different. Further, according to drilled objects in different materials, the main thread 33 and the auxiliary threads 35 can have variations in their thread shape, such as having asymmetric flank faces or having a large thread pitch. Accordingly, the high-low spiral arrangement constructed by the threads 33 and the auxiliary threads 35 helps the fastener 3 reduce the drilling resistance, thereby promoting the smoothness of the drilling action and attaining the firm screwing effect.

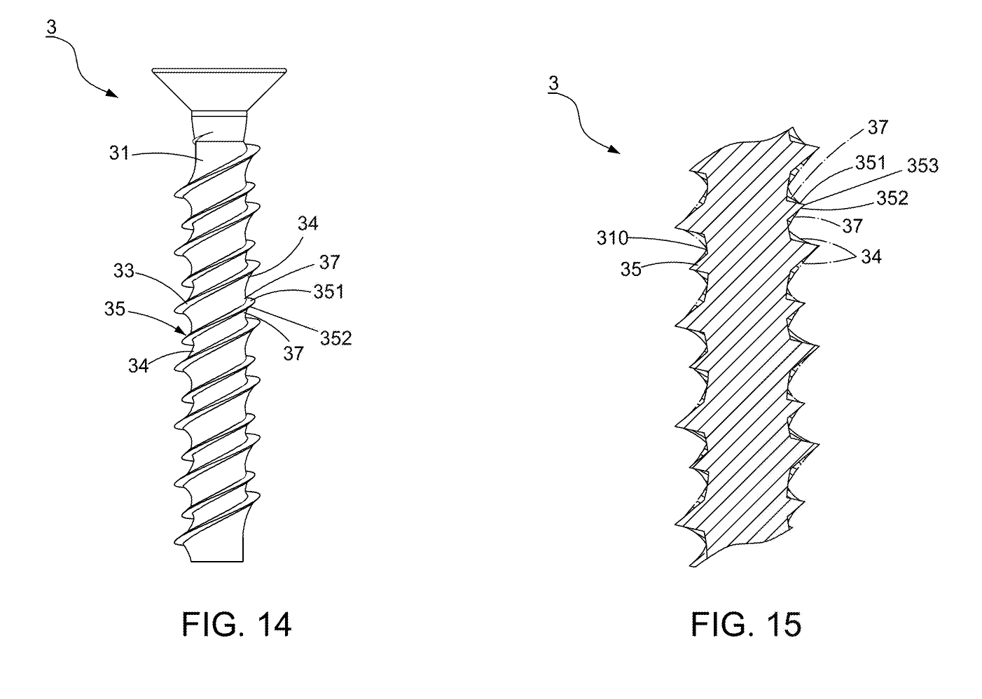

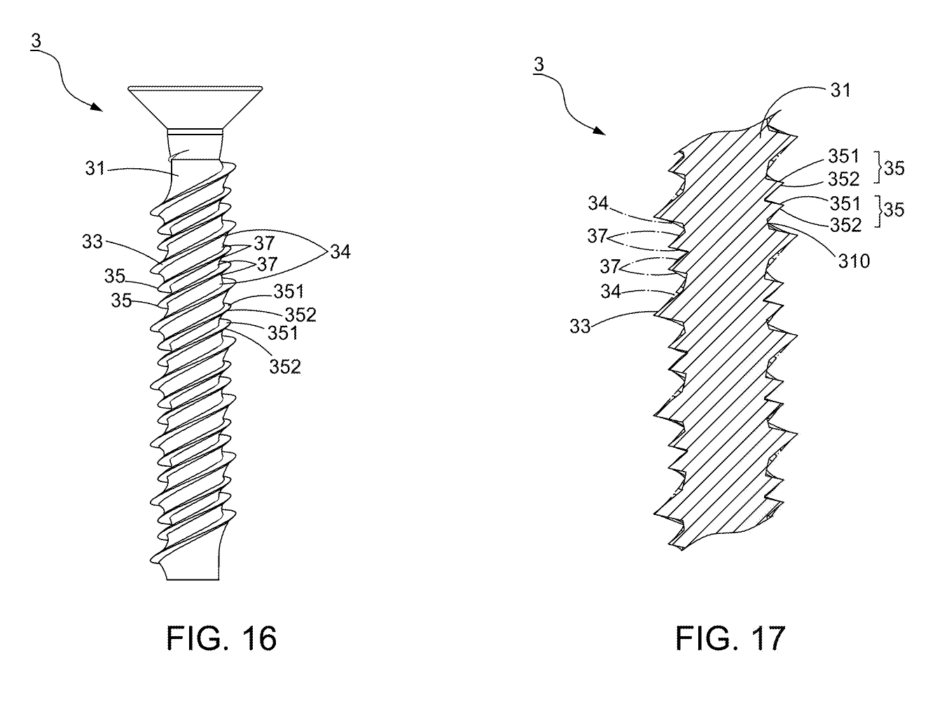

Referring to FIGS. 14-15, a sixth preferred embodiment of this invention has the same elements as those of the fourth embodiment. Particularly, this embodiment is to project at least one support lobe 37 from the shank 31. In other words, at least one support lobe 37 projects from the recessed root section 310 of the shank root to at least one auxiliary cutting face 351, 352 of the auxiliary thread 35. The support lobe 37 can be formed in a curved shape and flare outward to at least a midpoint of either one or both of the auxiliary cutting faces 351, 352 between the recessed root section 310 and the auxiliary edge 353. This support lobe 37 is also applied to the structure of FIG. 12, and the combination is shown in FIGS. 16-17 by having the support lobes 37 projecting from the recessed root section 310 to at least one or all auxiliary cutting faces 351, 352 of the two auxiliary threads 35. Therefore, the shank 31 with the main lobes 34 in cooperation with the support lobes 37 forms a multi-curved design projecting from the recessed root section 310 to obtain a stable support effect for the main threads 33. The support performance allows the fastener 3 to be drilled into the object more firmly and stably and prevents a reaming problem caused by a swinging behavior of the fastener 3 and a poor screwing problem caused by the reaming situation. Therefore, the engagement between the fastener 3 and the object can be largely obtained.

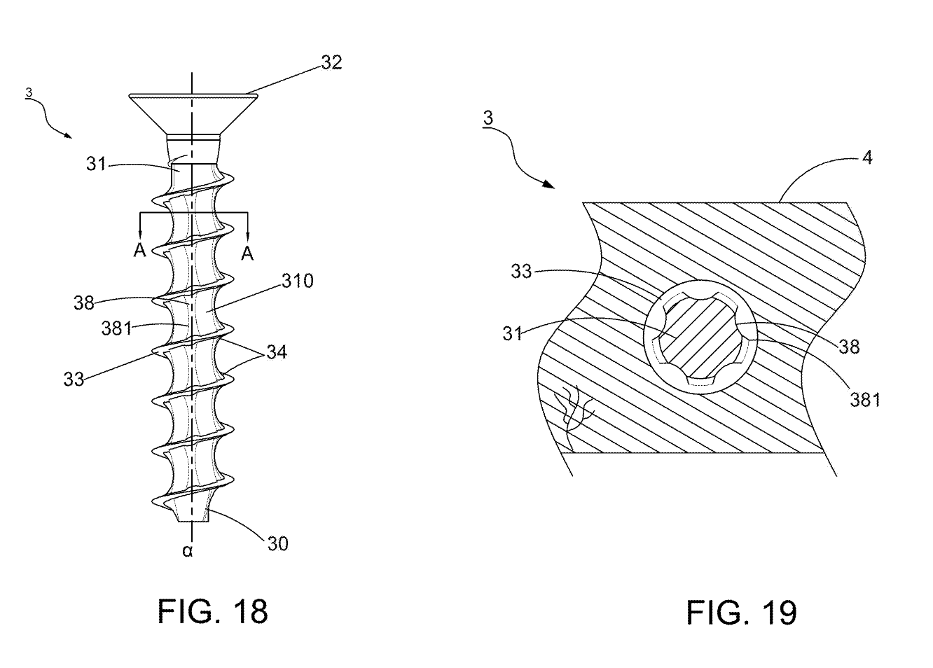

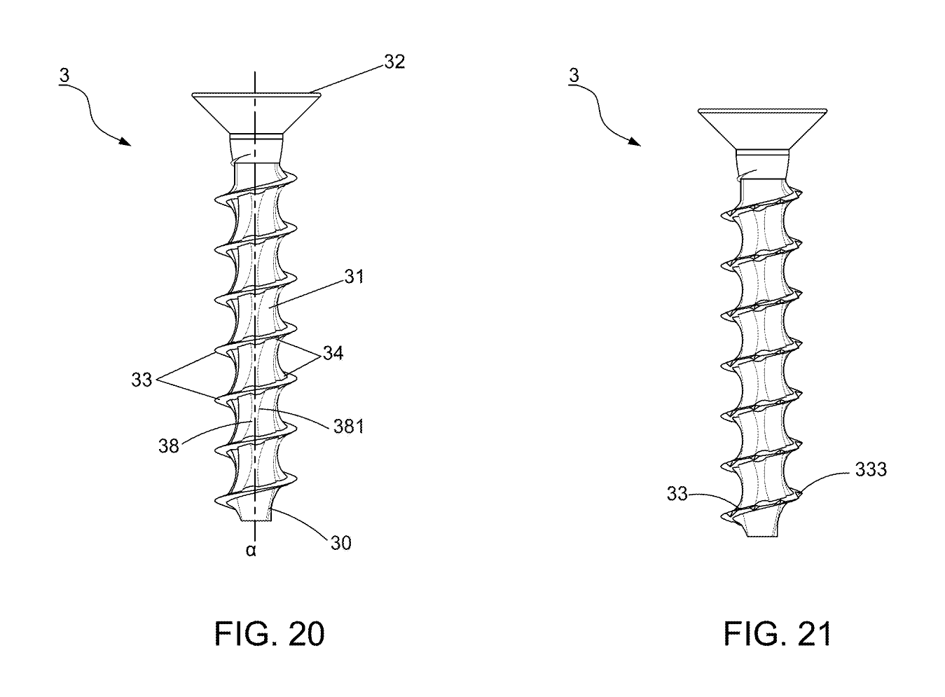

Referring to FIGS. 18-19, an eighth preferred embodiment of this invention still has a shank 31, a head 32, main threads 33, at least one main lobe 34 and a drilling portion 30. The concatenation of correlated elements of the eighth preferred embodiment is still the same as that of the previous preferred embodiment, e.g. the third preferred embodiment. Particularly, this embodiment includes a plurality of slits 38 recessedly defined on the shank 31 and extended between two adjacent main threads 33. Each of the slits 38 is intersected with the recessed root section 310 of the shank 31 to form a cutting edge 381. The slit 38 can be parallel to or inclined to the shank axis α, shown in FIG. 18 and FIG. 20 respectively. While drilled in to the object, the fastener 3 takes advantage of the cutting edge 381 to have a rapid drilling and cutting operation. Some debris can be expelled by the slits 38 and the residual debris can be received in the slits 38, thereby increasing the engagement effect, preventing the resonant vibratory effect owing to external vibrations and promoting the smoothness of the drilling operation.

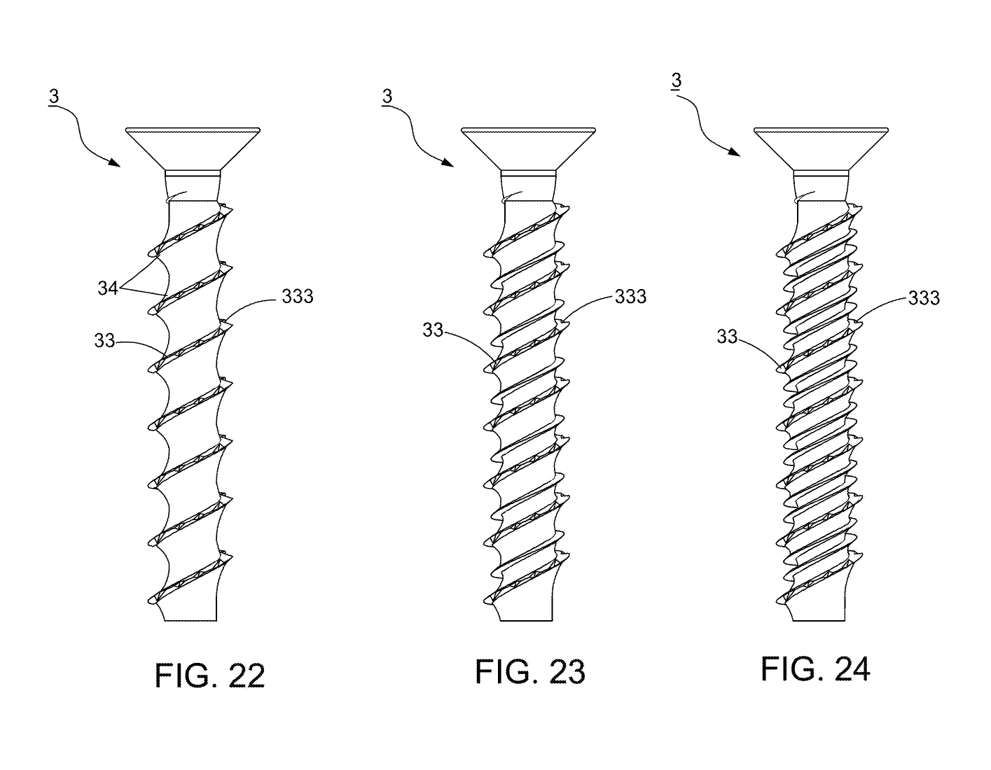

Referring to FIG. 21, a ninth preferred embodiment of this invention, having the same elements as those of the eighth embodiment, is characterized in that plural notches 333 are formed on each of the main threads 33. The notches 333 are also applied to different preferred embodiments presented supra. For example, FIGS. 22-24 show the notches 333 are incorporated into structures of FIG. 6, FIG. 14 and FIG. 16 respectively. By the main lobe 34 or the main lobe 34 in cooperation with the support lobe 37, good torsion resistance and tensile strength against the drilling stress can be attained to prevent the fastener 3 from snapping unintentionally. The notches 333 increase the cutting capability of the main threads 33 and facilitate the removal of the debris, thereby reducing the friction and drilling resistance and increasing the screwing efficiency and screwing engagement.

The advantages of this invention are as follows:
1. Because the main thread 33 is inclined with respect to the shank axis α by 60 to 82 degrees, the main threads 33 are drilled into the object 4 with a large rotating angle to facilitate debris accommodation and firm engagement. Furthermore, the extension of the main lobe 34 from the recessed root section 310 to the main thread 33 provide the main threads 33 with a support power to resist the drilling stress and prevent the main threads 33 from breaking. The rotation resistance impinging on the main threads 33 is also decreased so that the main thread 33 cuts the object 4 sharply to drill rapidly.
2. When the fastener 3 is drilled into the object 4, the multi-curved arrangement constructed by the main lobe 34 and the support lobe 37 allows the threads 33, 35 to attain the preferable torque and flexibility and obtain the preferable torsion resistance and tensile strength for bearing the increasing drilling stress. Therefore, this invention prevents the fastener 3 from twisting and snapping unintentionally.
3. The shank 31 can define the slits 38 between two adjacent main threads 33 to accommodate some debris cut by the main threads 33 and can form the notches 333 to help the main threads 33 cut fibers whereby the fastener 3 is firmly screwed into the object 4. For the object 4 made from a material with plasticity, this invention prevents the fastener 3 from loosening easily and gives a high force resisting the drilling stress to the fastener 3 in order to increase the tensile strength and prevent the fastener 3 from loosening because of the resonant vibratory effect caused by external vibrations.

To sum up, this invention takes advantage of each main thread inclined with respect to a shank axis by 60 to 82 degrees to provide a larger rotating angle and facilitate an effective drilling efficiency and at least one main lobe projecting from the recessed root section of the shank to at least one cutting face of each main thread to allow the fastener to have a higher power to resist the drilling stress. Therefore, this invention prevents the fastener from snapping and reduces the resonant vibratory effect to promote a film fastening effect.

While the embodiments of this invention are shown and described, it is understood that further variations and modifications may be made without departing from the scope of this invention.

What is claimed is:

1. A fastener comprising:
a shank defining a shank root;
a head disposed on one end of said shank;
a drilling portion disposed on the other end of said shank; and
a plurality of main threads spirally disposed on said shank, said main threads dividing said shank root into a plurality of recessed root sections, each of said main threads including two inclined cutting faces extending respectively outward from any two adjacent recessed root sections to converge at an edge;
wherein each of said main threads is inclined with respect to a shank axis of said shank by 60 to 82 degrees, and at least one main lobe projecting from said recessed root section to at least one cutting face of each of said main threads, said main lobe flaring outward to at least a midpoint of said cutting face between said recessed root section and said edge of said main thread.

2. The fastener as claimed in claim 1, wherein said main lobe i formed in a curved shape.

3. The fastener as claimed in claim 1, wherein said recessed root section is formed in a curved shape.

4. The fastener as claimed in claim 1, wherein two main lobes project from any two adjacent recessed root sections to said two cutting faces of each of said main threads respectively.

5. The fastener as claimed in claim 1, wherein at least one auxiliary thread is disposed between any two adjacent main threads, a diameter of said auxiliary thread being smaller than a diameter of each main thread.

6. The fastener as claimed in claim 5, wherein said auxiliary thread includes two auxiliary cutting faces extending outward from the recessed root section respectively to converge at an auxiliary edge, at least one support lobe projecting from said recessed root section to at least one auxiliary cutting face of said auxiliary thread.

7. The fastener as claimed in claim 1, wherein said shank has a plurality of slits recessedly defined thereon and extending between two adjacent main threads, each of said slits being intersected with said shank root of said shank to form a cutting edge.

8. The fastener as claimed in claim 1, wherein said drilling portion has a helical section coming to a sharp leading point.

9. The fastener as claimed in claim 1, wherein each of said main threads includes a plurality of notches formed thereon.
